(19) United States
(12) Patent Application Publication
(10) Pub. No.: US 2006/0095341 A1
(43) Pub. Date: May 4, 2006

(54) Matching system and method for product requirement

(75) Inventor: Li Yu Huang, Taoyuan County (TW)

Correspondence Address: BACON & THOMAS, PLLC, 625 SLATERS LANE, FOURTH FLOOR, ALEXANDRIA, VA, 22314, US

(73) Assignee: Harvest Enterprise Co., Ltd., Taoyuan County (TW)

(21) Appl. No.: 11/251,920

(22) Filed: Oct. 18, 2005

(30) Foreign Application Priority Data
Oct. 18, 2004 (TW) 93131590

(51) Int. Cl. G06Q 30/00

(52) U.S. Cl. 705/26

(57) ABSTRACT

The present invention provides a product requirement matching system and the method thereof, implemented on a product requirement matching website connected to the Internet. The product requirement matching website comprises a product database to collect a large number of specifications and the characteristic curve of commercially available fans. When the user logs into the website of the present invention and inputs the required air volume range and the system impedance characteristic values, the website of the present invention will make a matching between the characteristic curves of commercially available fans and the system impedance curve to find a fan having an intersection point falling within the required air volume range, and then displays the matched fan on a product matching web page.

### FIELD OF THE INVENTION

The present invention relates to a product specification and application requirement matching system and the method thereof, more particularly to a requirement matching system for fan products and fan application environments and the method thereof.

### BACKGROUND OF THE INVENTION

When electronic and electrical system engineers need to conduct cooling designs for fans, they should decide an air volume required for the cooling of a particular system, and the air volume is determined by the power consumption of the system and the volume of heat dissipated to prevent the overheating of the system.

Generally speaking, system engineers need to consider the following factors when designing a ventilation component: optimum air flow efficiency, minimum suitable size, minimum noise level, minimum power consumption, maximum reliability, service life, and reasonable total cost. When system engineers choose a fan for a ventilation component, they need to know the air volume and the system impedance, wherein the required air volume can be calculated from the following formula:

$$Q ( {M}^{3} / Min . ) = \frac{0.09 \times P}{Δ Tf} = \frac{0.05 \times P}{Δ Tc}$$

Wherein
Q: Air volume required for cooling;
P: Heat dissipation inside the equipment (that is the power consumed by the equipment)
Tf: Allowed internal temperature rise (in Fahrenheit)
Tc: Allowed internal temperature rise (in Celsius)
DT=Temperature Difference between DT1 and DT2

The parts inside the system will result in a loss in wind pressure, and this loss will vary depending on wind volume. That is a so-called system impedance.

Therefore, system engineers are required to find a suitable fan among various fans from various fan manufacturers based on the above required air volume and system impedance, this is very time-consuming and laborious. Each fan has its own Operating Characteristic curve or specification. When system engineers decide a particular fan, the Operating Characteristic curve 10 and system impedance curve 20 of the fan are as shown in FIG. 1. The focus of the Operating Characteristic curve and the system impedance curve is called a system operating point, and the air volume corresponding to the system operating point is the required air volume. In other words, system engineers decide the system operating point from the required air volume corresponding to the system impedance curve. The most difficult task is to find among a large number of fans a product whose Operating Characteristic curve passes through the system operating point.

Fans are selected primarily based on their cooling efficiency, and the service life of a system will decrease due to the inefficiency in the cooling. Therefore, system engineers should also know that the sale volume and price of systems may decrease due to the service life of the system does not meet the user's expectation.

### SUMMARY OF THE INVENTION

It is one object of the present invention to provide a product requirement matching system that builds a digitalized fan characteristic curve to match the air volume and the system impedance provided by a user, and the method thereof.

The second object of the present invention is to provide a fan requirement matching method matching the system requirements provided by a user by means of a digitalized fan characteristic curve.

The third object of the present invention is to provide a fan requirement matching website having a digitalized fan characteristic curve database and providing a required system interface web page.

The present invention provides a product requirement matching system comprising:

a product database to record digitalized fan characteristic values of a plurality of fans;

an input interface unit to input the required air volume or static pressure and the system impedance characteristic value; and

a data processing unit to calculate the system impedance curve of system impedance characteristic values and the fan characteristic curves of fan characteristic values, so as to make a matching between the fan characteristic curves and the system impedance curve to find a fan whose intersection point is substantially equivalent to the fan having the required air volume or static pressure.

The present invention provides a product requirement matching website connected to the Internet, comprising:

a product database to record digitalized fan characteristic values of a plurality of fans;

a web page interface unit to provide a web page which comprises the inputs of the required air volume range or the required static pressure range and the system impedance characteristic values; and

a data processing unit to calculate the system impedance curve of system impedance characteristic values and the fan characteristic curves of digitalized fan characteristic values so as to make a matching between the fan characteristic curves and the system impedance curve to find a fan having an intersection point falling within the required air volume range or the required static pressure range.

The present invention provides a product requirement matching method comprising the steps of:

building a product database, which stores digitalized fan characteristic values of a plurality of fans;

inputting the required air volume range or the required static pressure range and the system impedance characteristic values;

calculating the system impedance curve of system impedance characteristic values and the fan characteristic curve of digitalized fan characteristic values; and

making a matching between the fan characteristic curves and the system impedance curve to find a fan having an intersection point falling within the required air volume range or the required static pressure range.

According to the product requirement matching system and the method of the above embodiments of the present invention, system engineers are able to rapidly obtain commercially available fans that meet the required air volume and system impedance, thereby saving the time in studying the fan characteristics of various manufacturers and finding a suitable one. The system and the method of the present invention also provide fan manufacturers with the system impedance required by the market as the reference for manufacturing fans, in hopes of increasing product diversification and sale volume.

### BRIEF DESCRIPTION OF THE DRAWINGS

The above objects and advantages of the present invention will become more apparent with reference to the appended drawings wherein:

FIG. 1 is a schematic view of the matching between the fan characteristic curve and the system impedance curve for a fan.

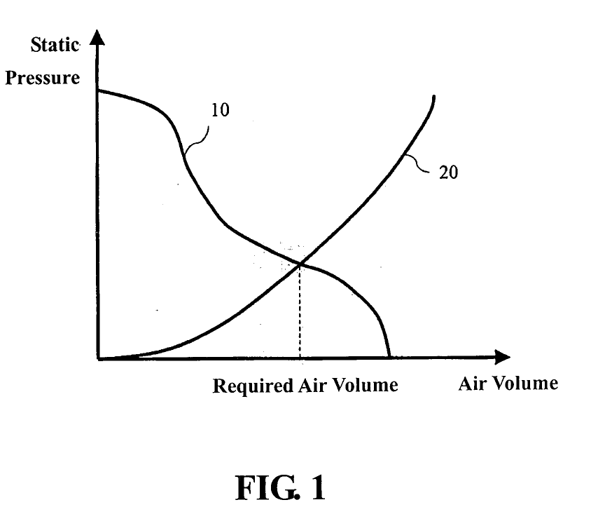

FIG. 2 is a structural view of the product requirement matching system of the present invention.

FIG. 3 shows a schematic view of the fan characteristic curve of the embodiment of the present invention and the fan characteristic values thereof.

FIG. 4 shows a schematic view of the system impedance curve of the embodiment of the present invention and the system impedance characteristic values thereof and the required air volume range A Q.

FIG. 5 shows a block diagram of the product requirement matching website of the present invention.

FIG. 6 shows a flow chart of the product requirement matching method of the present invention.

### DETAILED DESCRIPTION OF THE INVENTION

Although the present invention has been described in considerable detail with reference to certain preferred embodiments thereof, however prior to this description, it is should to be understood that those skilled in the art can easily make changes to the present invention described herein and the same performance as the present invention is obtained. Therefore, it is to be understood that the following description is a general disclosure to those skilled in the art and is not restrictive of the present invention.

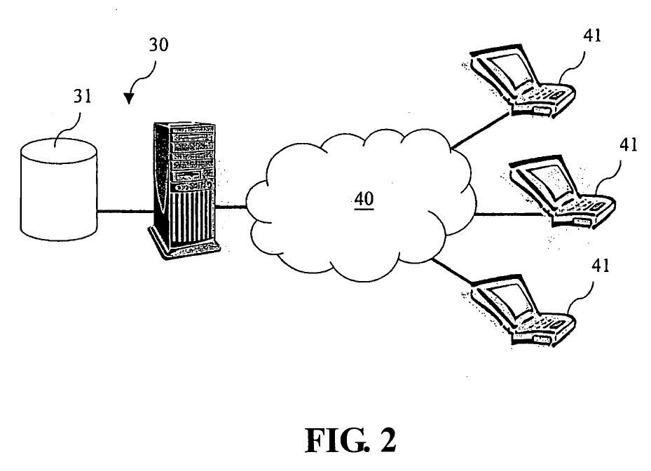

Referring to FIG. 2, a structural view of the product requirement matching system of the present invention is shown. This product requirement matching system is implemented on a product requirement matching website 30 built on the Internet 40. The product requirement matching website 30 provides users 41 with online web page contents. The product requirement matching website 30 is implemented with a server having a product database 31, which collects the specifications of fans manufactured by major fan manufacturers in the market and their fan characteristic curves. The data of each fan generally comprise the name, address, and telephone number of fan manufacturers; and the fan characteristic curve, product model number, product volume, specified voltage, specified current, maximum rotational speed, air volume, noise level, etc. of fan products.

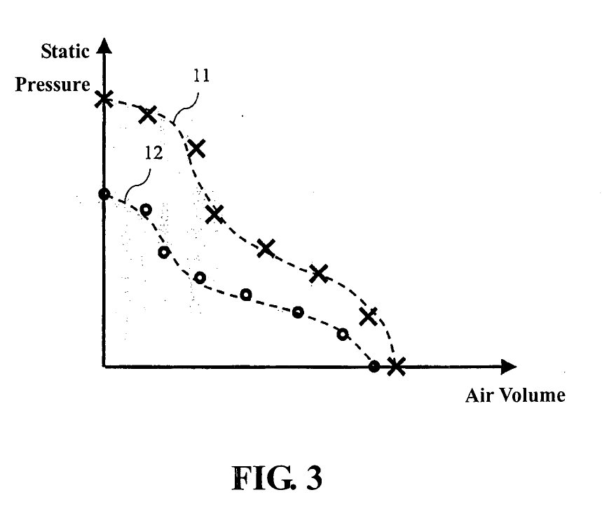

In a preferred embodiment of the present invention, the fan characteristic curve is digitalized as a plurality of fan characteristic values and stored in the product database 31. Referring to FIG. 3 for a schematic view of the fan characteristic curve of the present invention and the fan characteristic values thereof, each fan model number corresponds to a fan characteristic curve. Taking two fan characteristic curves, 11, 12 for two different fan model numbers as an example, the fan characteristic curve 11 denotes eight fan characteristic values by “X” whereas the fan characteristic curve 12 denotes eight fan characteristic values by “◯”. Each fan characteristic value is a coordinate defined by an air volume value and a corresponding static pressure value. Therefore, the product database 31 stores the eight coordinates of the fan characteristic values of the fan characteristic curve 11. When the system and the method of the present invention needs to make product matching, a fan characteristic curve that approximates different fan characteristic values will be calculated based on a plurality of fan characteristic values of each fan by the simulation of mathematical formulae. The more fan characteristic values recorded for a fan, the closer the fan characteristic curve approximates the actual fan characteristic curve by the simulation of mathematical formulae.

When the system engineer accesses the product requirement matching website 30 via the Internet 40, the product requirement matching website 30 provides a login page to recognize the identity of the system engineer 41. Once the login is confirmed, the product requirement matching website 30 can provide a product requirement web page, which comprises the inputs of fan specifications, required air volume range and system impedances. For example, the system engineer can click on specification items such as product volume, specified voltage, specified current, and maximum rotational speed, and then enter the input values of these specification items, as well as the required air volume range and the system impedances.

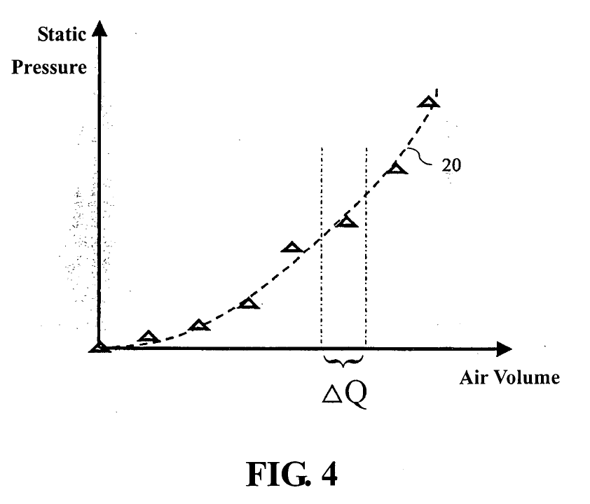

In a preferred embodiment of the present invention, the system impedance input values are a plurality of input system impedance characteristic values. Referring to FIG. 4 for a schematic view of the system impedance curve of the present invention and the system impedance characteristic values thereof, and the required air volume range ΔQ. The system impedance curve 20 denotes eight system impedance characteristic values by “Δ”. The system engineer estimates the system impedance curve of a equipment based on the cooling environment of a particular system, retrieves a plurality of system impedance characteristic values from the system impedance curve evenly and then inputs them into the input column of system impedance of the product requirement web page. Each system impedance characteristic value is a coordinate defined by an air volume value and a corresponding static pressure value. The more system impedance characteristic values that the system engineer inputs, the closer the system impedance curve obtained by the system and method of the present invention by the simulation of mathematical formulae approximates the actual system impedance curve.

When the website 30 that implements the system and the method of the present invention obtains the input values of specification items, required air volume range and system impedances clicked and inputted by the system engineer from the product requirement web page, the website 30 will calculate the system impedance curve and calculate different fan characteristic curves from the product database 31 to make a matching between the fan characteristic curves and the system impedance curve to find a fan having an intersection point falling within the required air volume range and meeting all clicked specification items. The product requirement matching website 30 will provide a product matching web page, which includes information associated with all fans meeting the clicked specification items upon the matching procedure, such that the system engineer can rapidly obtain the required fan to match the designed ventilation component or cooling component.

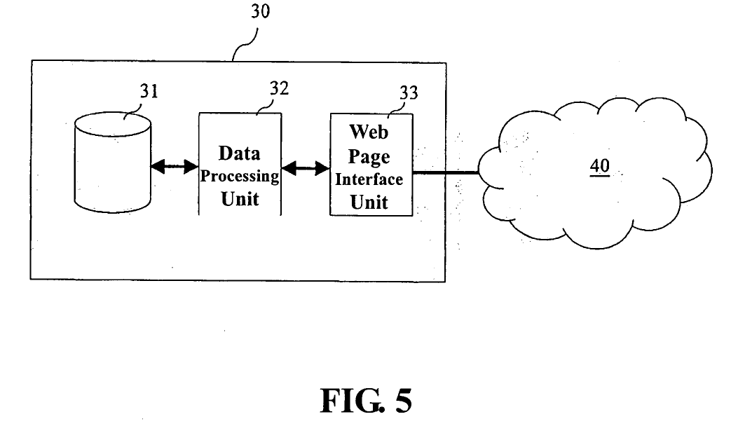

Referring to FIG. 5 for a block diagram of the product requirement matching website of the present invention, the product requirement matching website 30 implemented in accordance with the system and the method of the present invention is connected to an Internet 40, comprising: a product database 31 to record digitalized fan characteristic values of a plurality of fans; a web page interface unit 33 to provide the contents for a login web page, a product requirement web page, and a product matching web page; and a data processing unit 32 to calculate the system impedance curve of system impedance characteristic values and the fan characteristic curve of digitalized fan characteristic values based on the data inputted on the product requirement web page and the product database 31, so as to make a matching between the fan characteristic curves and the system impedance curve to find a fan having an intersection point falling within the required air volume range and meeting all clicked specification items, wherein the web page interface unit 33 and the data processing unit 32 can be implemented by software programs.

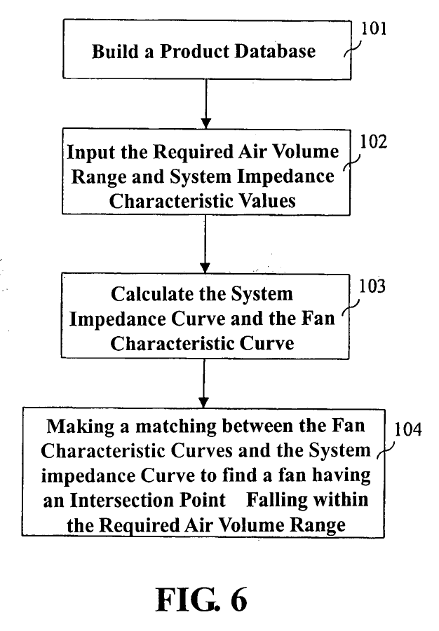

Referring to FIG. 6 for a flow chart of the product requirement matching method of the present invention. According to a preferred embodiment of the present invention, the product requirement matching method implemented on the product requirement matching website 30 comprises:

Step 101: building a product database 31 to record the specifications and fan characteristic curves of all commercially available fans of various fan manufacturers, wherein the fan characteristic curve of each fan is recorded as a plurality of digitalized fan characteristic values, whereas the specification includes the name, address, and telephone number of fan manufacturers; and the product model number, product volume, specified voltage, specified current, maximum rotational speed, air volume; noise level, etc. of fan products.

Step 102: providing a product requirement web page, which comprises the inputs of various specification items of fans, the required air volume range, and the system impedances, wherein the system impedance input values are the inputs of a plurality of system impedance characteristic values.

Step 103: calculating the system impedance curve of system impedance characteristic values by the simulation of mathematical formulae, and calculating the fan characteristic curves of various fans stored in the product database 31.

Step 104: first filtering the fans that meet specification items stored in the product database 31, and then making a matching between the fan characteristic curves and the system impedance curve to find a fan having an intersection point falling within the required air volume range, and finally providing a product matching web page to show the related information of the fan expected by the system engineer.

The product requirement matching website 30 according to the system and method of the present invention not only rapidly provides the system engineer with the fan that meets the required air volume and system impedance, required system environmental data (such as various specification items, required air volume range, and system impedances inputted by system engineers) of fans applied in various system designs are also collected, filed, and stored. All the information is of industrial utilization value to manufacturers, and can be taken as reference for fan manufacturing, in hopes of increasing product diversification and sale volume.

Having described the preferred embodiments of this invention, it should be readily apparent to those skilled in the art that the invention can be modified and changed without departing from the scope and spirit of this invention. Further, this invention is also not limited to the implementations of the embodiments disclosed in this specification.

What is claimed is:

1. A product requirement matching method, comprising the steps of:
building a product database, to store digitalized fan characteristic values of a plurality of fans;
inputting a required air volume range or a required static pressure range and system impedance characteristic values;
calculating the system impedance curve of system impedance characteristic values and the fan characteristic curves of fan characteristic values; and
making a matching between the fan characteristic curves and the system impedance curve to find a fan having an intersection point falling within the required air volume range or the required static pressure range.

2. The product requirement matching method as claimed in claim 1, comprising the step of: recording a plurality of fan characteristic values corresponding to each fan, and each fan characteristic value is a coordinate defined by an air volume value and a corresponding static pressure value.

3. The product requirement matching method as claimed in claim 1, comprising the step of: inputting a plurality of system impedance characteristic values, and each system impedance characteristic value is a coordinate defined by an air volume value and a corresponding static pressure value.

4. The product requirement matching method as claimed in claim 1, comprising the step of: confirming the specification items of fan requirements, and inputting the values of the specification items.

5. The product requirement matching method as claimed in claim 1, comprising the step of: simulating and calculating the system impedance curve of system impedance characteristic values and the fan characteristic curves of fan characteristic values by mathematical formulae.

6. The product requirement matching method as claimed in claim 1, comprising the step of: collecting the specifications of commercially available fans and recording them in said product database.

7. The product requirement matching method as claimed in claim 6, comprising the step of: collecting specifications such as product model number, product volume, specified voltage, specified current, maximum rotational speed, air volume, and noise level.

8. A method of product requirement matching website, comprising the step of:
building a product database to collect the specifications of commercially available fans and the fan characteristic values;
providing a product requirement web page, comprising the inputs of the specifications items of fans, the required air volume range or the required static pressure range and the system impedance characteristic values;
calculating the system impedance curve of system impedance characteristic values and the fan characteristic curves of fan characteristic values a;
filtering the commercially available fans from the product database, based on the inputs of specification items, and making a matching between the fan characteristic curves of the filtered fans and the system impedance curve to find a fan having an intersection point falling within the required air volume range or the required static pressure range; and
providing a product matching web page to display the specifications of the matched fans.

9. The method of product requirement matching website as claimed in claim 8, comprising the step of: recording a plurality of fan characteristic values corresponding to each fan, and each fan characteristic value is a coordinate defined by an air volume value and a corresponding static pressure value.

10. The method of product requirement matching website as claimed in claim 8, comprising the step of: inputting a plurality of system impedance characteristic values, and each system impedance characteristic value is a coordinate defined by an air volume value and a corresponding static pressure.

11. The method of product requirement matching website as claimed in claim 8, comprising the step of: simulating and calculating the system impedance curve of system impedance characteristic values and the fan characteristic curves of fan characteristic values by mathematical formulae.

12. The method of product requirement matching website as claimed in claim 8, comprising the step of: collecting specifications such as product model number, product volume, specified voltage, specified current, maximum rotational speed, air volume, and noise level.

13. A product requirement matching system, comprising:
a product database, to record digitalized fan characteristic values of a plurality of fans;
an input interface unit, to input the required air volume or static pressure and the system impedance characteristic values; and
a data processing unit to calculate the system impedance curve of system impedance characteristic values and the fan characteristic curves of fan characteristic values so as to make a matching between the fan characteristic curves and the system impedance curve to find a fan having an intersection point generally equivalent to the required air volume or static pressure of.

14. The product requirement matching system as claimed in claim 13, wherein said input interface unit provides a product requirement web page, which comprises the inputs of various specification items, required air volume range and the system impedance characteristic values of fans.

15. The product requirement matching system as claimed in claim 14, wherein said specification items of said product requirement web page include product volume, specified voltage, specified current, maximum rotational speed, air volume, and noise level.

16. The product requirement matching system as claimed in claim 13, wherein said product database further records fan specifications of fans, comprising: product model number, product volume, specified voltage, specified current, maximum rotational speed, air volume, and noise level.

17. A product requirement matching website, connected to an Internet, comprising:
a product database to record digitalized fan characteristic values of commercially available fans;
a web page interface unit to provide the inputs of the required air volume range or the required static pressure range and the system impedance characteristic values, and the output of the matched product; and
a data processing unit to calculate the system impedance curve of system impedance characteristic values and the fan characteristic curves of fan characteristic values so as to make a matching between the fan characteristic curves and the system impedance curve to find a commercially available fan having an intersection point falling within the required air volume range or the required static pressure range.

18. The product requirement matching website as claimed in claim 17, wherein said web page interface unit provides a product requirement web page, which comprises the inputs of various specification items, required air volume, and system impedance characteristic values of commercially available fans.

19. The product requirement matching website as claimed in claim 17, wherein said product database further records specifications of commercially available fans, comprising: product model number, product volume, specified voltage, specified current, maximum rotational speed, air volume, and noise level, and said web page interface unit provides a product matching web page to display the specifications of the matched commercially available fan.

20. The product requirement matching website as claimed in claim 17, wherein said system impedance characteristic value is a coordinate defined by an air volume value and a corresponding static pressure value, and the fan characteristic value is a coordinate defined by an air volume value and a corresponding static pressure value.
